(19) United States
(12) Patent Application Publication
(10) Pub. No.: US 2013/0007622 A1
(43) Pub. Date: Jan. 3, 2013

(54) DEMONSTRATING A SOFTWARE PRODUCT

(75) Inventors: Bruce TJ Ke, New Taipei (TW); Freddy PL Lu, New Taipei City (TW); Giant HM Tu, Taipei (TW); Jason CS Yang, Taipei (TW)

(73) Assignee: INTERNATIONAL BUSINESS MACHINES CORPORATION, Armonk, NY (US)

(21) Appl. No.: 13/536,138

(22) Filed: Jun. 28, 2012

(30) Foreign Application Priority Data
Jun. 30, 2011 (TW) 100123288

(51) Int. Cl. G06F 3/048; G06F 15/16

(52) U.S. Cl. 715/733

(57) ABSTRACT

A method for demonstrating a software product that includes providing by a server, in response to a software product selected by a user via a terminal device, graphical user interface (GUI) shadow data created using predetermined event information and actions for downloading by the terminal device. The GUI shadow data enables the terminal device to demonstrate the software product. Additionally, a system and computer program product for demonstating software are described.

### PRIORITY

The present application claims priority to Taiwan Patent Application No. 100123288, filed on Jun. 30, 2011, and all the benefits accruing therefrom under 35 U.S.C. §119, the contents of which in its entirety are herein incorporated by reference.

### BACKGROUND

The present invention relates to demonstrating a software product. More specifically, the present invention relates to graphical user interface (GUI) shadow data for demonstrating a software product.

Due to the wide use of computer networks, there is a mainstream trend toward online downloading of software products and thus, many types of software can be obtained or purchased by means of online downloading from various online software stores. Software products may be downloaded to computing devices, such as terminal devices. For example, U.S. Patent Application Publication No. 2009/0307105 “User interface for Application Management for a Mobile Device” by Lemay et al., describes an example of accessing an online software store with a terminal device.

A user may gain insight into a software product through a screenshot or a pamphlet provided by a software product manufacturer or through a comment made by another user. However, such information may not be effective in enabling the user to understand how the software product works. As a result, the user may regret purchasing a software product after first purchasing the software product and then discovering that the software product is unable to meet user needs.

Software product manufacturers sometimes offer free “lite” versions or trial versions to users; however, in doing so, the manufacturers incur increased costs in development and maintenance. In addition, the use of lite versions requires users to install software on their computers in order to determine whether a software product meets their requirements. Other drawbacks to the use of lite versions include the time spent by the users, memory space required on user devices, and network transmission expenses.

### BRIEF SUMMARY

According to an exemplary embodiment, a terminal device connected to a server includes a processor for executing a management program. The management program performs a method that includes providing a management interface to a user and receiving a selection of a software product from the user via the management interface. Graphical user interface (GUI) shadow data corresponding to the software product is downloaded from the server. The software product on the terminal device is demonstrated according to the GUI shadow data.

According to another exemplary embodiment, a method for demonstrating a software product on a terminal device includes providing a management interface associated with a management program to a user by the terminal device and receiving a selection of a software product from the user via the management interface. GUI shadow data corresponding to the software product is downloaded from a server. The software product on the terminal device is demonstrated according to the GUI shadow data.

According to another exemplary embodiment, a computer program product for demonstrating a software product on a terminal device includes a computer readable storage medium having computer readable program code embodied therewith. The computer readable program code includes computer readable program code configured to provide a management interface associated with a management program to a user. The computer readable program code is also configured to receive a selection of a software product from the user via the management interface and to send GUI shadow data corresponding to the software product from a server to the terminal, thereby enabling demonstration of the software product on the terminal device according to the GUI shadow data.

According to a further exemplary embodiment, a method for demonstrating a software product includes providing by a server, in response to a software product selected by a user via a terminal device, GUI shadow data created using predetermined event information and actions for downloading by the terminal device. The GUI shadow data enables the terminal device to demonstrate the software product.

### BRIEF DESCRIPTION OF THE SEVERAL VIEWS OF THE DRAWINGS

The drawings referenced in the present application are only used to exemplify typical embodiments of the present invention and should not be considered to be limiting the scope of embodiments of the present invention.

FIG. 1 illustrates a terminal device according to an embodiment of the present invention;

FIG. 2 is a flowchart of a method for demonstrating a software product on a terminal device using GUI shadow data according to an embodiment of the present invention;

FIG. 3 is a flowchart of a method for creating GUI shadow data according to another embodiment of the present invention;

FIGS. 4A and 4B show examples of two usage scenarios executed by the developer according to embodiments of the present invention; and

FIG. 5 shows an example of a software demonstration using to GUI shadow data according to embodiments of the present invention.

### DETAILED DESCRIPTION

Embodiments of graphical user interface (GUI) shadow data for demonstrating a software product on a terminal device, and a method for demonstrating a software product on a terminal device using GUI shadow data, are provided, with exemplary embodiments being discussed below in detail. GUI shadow data may be created using developer-predetermined event and action information. Demonstration is performed by means of the GUI shadow data. A GUI element as defined by the GUI shadow data may be capable of dynamic demonstration and interaction with a user via the terminal device. Therefore, the GUI shadow data may assist the user in understanding how the software product works. Furthermore, downloading of only the GUI shadow data may be required to demonstrate a software product on the terminal device, resulting in reduced amounts of downloaded data and providing faster download times as compared to downloading a full version of the software product.

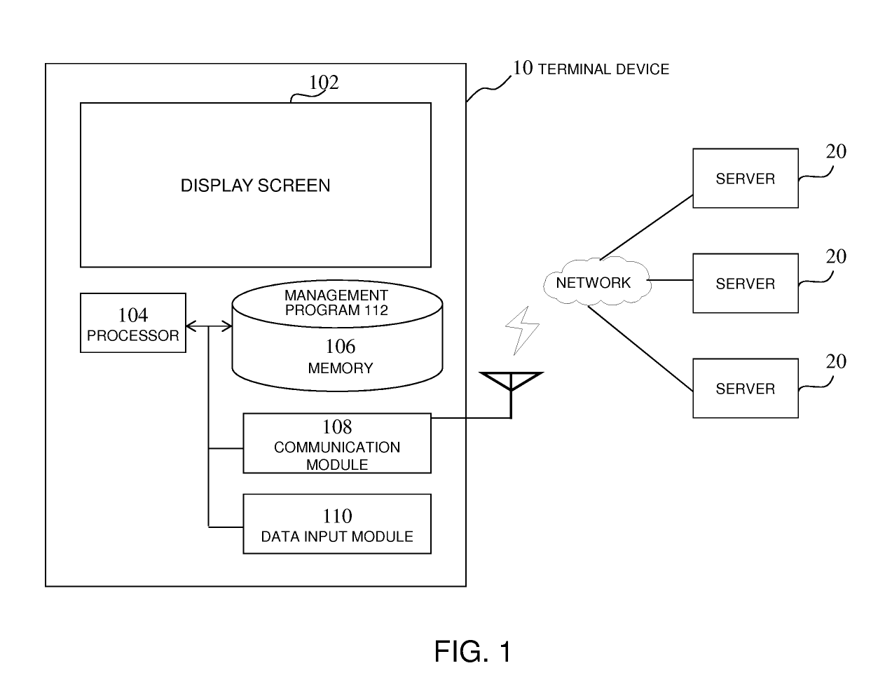

FIG. 1 illustrates a block diagram of a terminal device 10 in an embodiment. The terminal device 10 includes a display screen 102, a processor 104, a memory 106, a communication module 108, and a data input module 110. The terminal device 10 may be any user device such as a notebook computer or a portable information device or a mobile device. The processor 104 may be a central processor intended for use with a specific type of terminal device 10 (e.g., a mobile device). The memory 106 may be a flash memory for storing a management program 112 to be accessed and executed by the processor 104. The communication module 108 is capable of providing a network connection according to a communication protocol, such as universal mobile telecommunications system (UMTS), global system for mobile communications (GSM), or wireless fidelity (Wi-Fi). Communication module 108 may be connected to one or more servers 20. The data input module 110 may be a digital camera module for entering image data or barcode data in some embodiments. In further embodiments, the data input module 110 and the display screen 102 may be integrated to form a touchscreen to which a user enters data. The servers 20 may be independent of each other, may be integrated with a file transfer protocol (FTP) server, or may be integrated with a server from which a software product is downloadable in various embodiments. The servers 20 may be integrated with an online software store server in some embodiments.

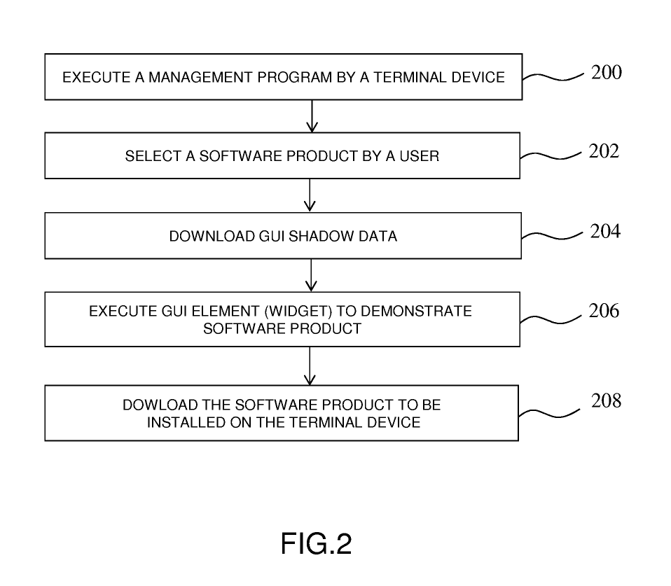

FIG. 2 is a flow chart of a method for use with the terminal device 10 shown in FIG. 1. First, in block 200 of FIG. 2, the user executes a management program 112 at the terminal device 10. In some embodiments, the management program 112 is an online software store management program 112 for accessing a server of an online software store, wherein the server is implemented in the form of the servers 20 shown in FIG. 1. Next, in block 202, the management program 112 provides a management interface (not shown), and the user selects a software product available at the servers 20 through the management interface. Details of blocks 200 and 202 may be performed as is described in U.S. Patent Application Publication No. 2009/0307105 in some embodiments.

Next, in block 204, after the user has selected a specific software product at the management interface (for example, by selecting from a menu or searching the interface) of the management program 112, but before the user confirms downloading the software product, the management program 112 downloads GUI shadow data from the servers to the memory 106 of the terminal device 10. As described below, a developer of the software product operates the software product in a predetermined usage scenario and interacts with a GUI element, or widget, to thereby record the “event” information including the GUI element and operation of the GUI element (such as clicking thereon to effectuate an input) by the developer and a response “action” taken by the software product for executing the operation. The GUI shadow data are created according to the recorded “event” information and “action”. The GUI shadow data can be in any data format, such as an extensible markup language (XML) language format. In some embodiments, the GUI elements are GUI elements such as those described in U.S. Pat. No. 7,861,180 or U.S. Pat. No. 7,694,271.

GUI shadow data may be downloaded in the background of the management program 112, so as to allow the user to experience enhanced ease of use. That is to say, after selecting a specific software product at the management interface, the user need not give any further input or command, because the management program 112 downloads the GUI shadow data automatically. In another embodiment, the management program 112 may download the GUI shadow data only in response to a command given by the user, such as clicking on a specific icon provided at the management interface.

Then, in block 206 of FIG. 2, after the GUI shadow data has been downloaded, the management program 112 demonstrates operations or functions provided by a software product according to associated event-action information in the GUI shadow data, in response to a command (such as clicking on a specific icon provided at the management interface) given by the user. The management program 112 is equipped with a GUI analysis engine for processing the GUI shadow data, so as to demonstrate operations or functions provided by the software product.

Since the GUI shadow data is capable of dynamic demonstration and interaction with a user, the GUI shadow data is effective in assisting the user in understanding how the software product works. The recorded GUI element event-action information may be displayed in a window, or the management interface of the management program 112. Hence, the user may watch the software product recorded by GUI shadow data recorded and demonstrated in the same interface, thereby dispensing with the inconveniences of instantiating or switching to another interface (such as a special browser) provided by another application in order to watch the demonstration of the software product.

A predetermined usage scenario of the software product may be demonstrated according to the GUI shadow data. That is to say, the GUI shadow data may not demonstrate all functions or operations of the software product in some embodiments. A specific operation and result in the software product may be demonstrated solely according to dynamic or interactive frames provided by the GUI shadow data in block 204, thereby dispensing with the inconveniences of giving considerations to all possible usage scenarios that are required for a complete software product. The GUI shadow data demonstrates a predefined event-action in block 204, and the GUI analysis engine operates according to the predefined event-action in block 206. For example, an event may refer to the user's clicking on a GUI element or clicking on multiple GUI elements in sequence. Corresponding to an event, a response action may be given by the software product; for example, a new dialog box, an adjustment of a screen setting, or presentation of specific data. In doing so, a predetermined usage scenario of the software product is demonstrated by interacting with a user according to the GUI shadow data.

Lastly, in block 208 of FIG. 2, after the user has finished watching the demonstration according to the GUI shadow data and thus gains understanding of the operation of the software product, the user may download from the servers 20 the software product to be installed on the terminal device 10.

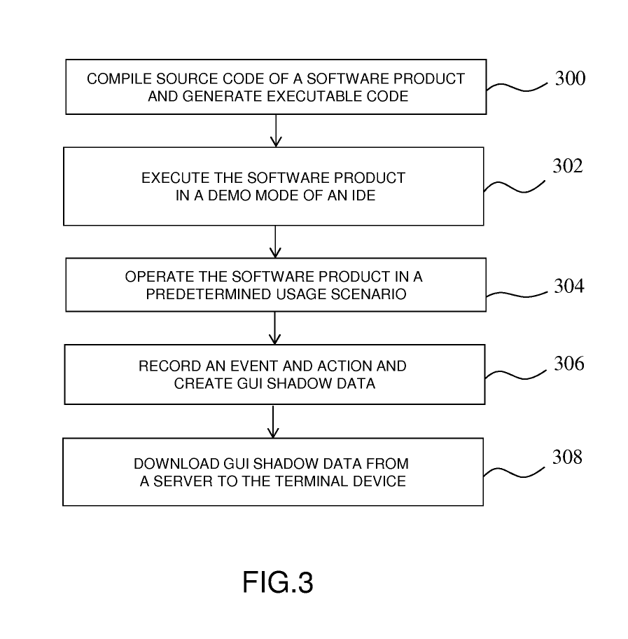

FIG. 3 is a flow chart of a method for creating GUI shadow data for use with the terminal device 10 of FIG. 1 according to an embodiment of the present invention. The method of FIG. 3 may be designed to be performed in an integrated development environment (IDE) of the software product in some embodiments. A developer may create the GUI shadow data for demonstration of the software product in the same IDE that is used for compiling the source code of the software product, thereby cutting the costs incurred in development and maintenance carried out by the developer. First, in block 300 of FIG. 3, the source code of the software product may be compiled in an IDE to generate executable code. The IDE tool may comprise any appropriate IDE.

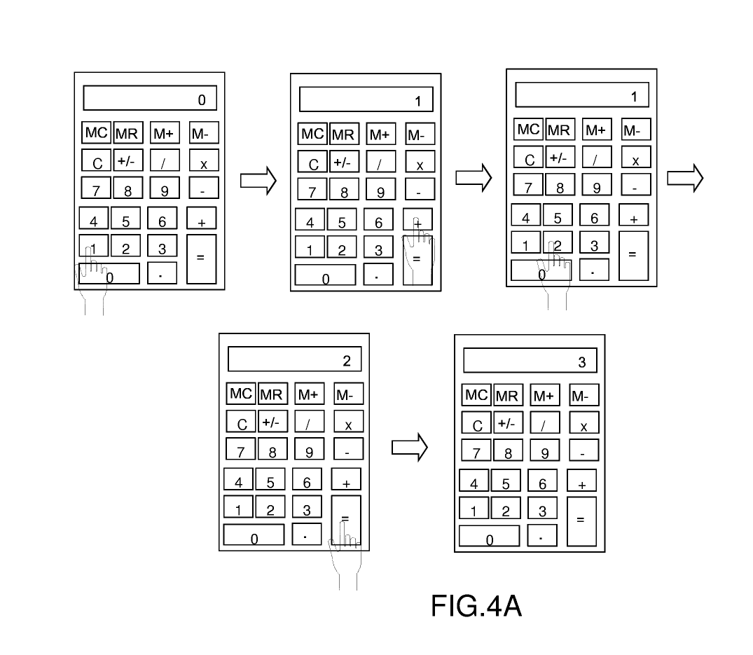

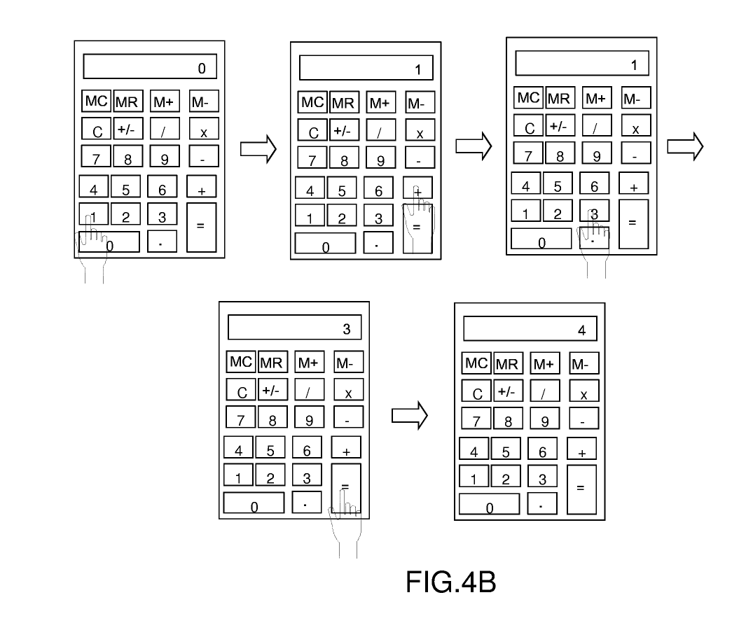

Next, in block 302 of FIG. 3, the executable code of the software product, which was compiled in block 300, is executed in a demo mode of the IDE. Then, in block 304, the developer operates the software product in the demo mode according to a predetermined usage scenario, wherein the operation includes, for example, clicking to enter or keying in a character. In the examples shown in FIGS. 4A and 4B, the software product is visualized touch-controlled computer software. The developer executes two usage scenarios described below in block 302 of FIG. 3.

Referring to FIG. 4A, the developer clicks on “1”, “+”, “2”, “=” in sequence to execute a computation operation of “1+2=”, and then the software product responds with a result “3” and displays the developer's input and operation result sequentially in a result window on the visualized computer. Referring to FIG. 4B, the developer clicks on “1”, “+”, “3”, “=” in sequence to execute a computation operation of “1+3=”, and then the software product responds with a result “4” and displays the developer's input and operation result sequentially in a result window on the visualized computer.

Next, in block 306 of FIG. 3, in the usage scenario that was executed in block 304, GUI elements functioning as event information are recorded, along with an operation (such as clicking to input) performed by the developer thereon, and a response action made to the operation executed by the software product. The GUI shadow data is created according to the recorded event and action information. In an embodiment of the present invention, the associations between event information and action information may be presented in an XML format. A record and stop button may be provided in the IDE for the IDE to determine the start and the end of a usage scenario to be recorded for creation of the GUI shadow data. Furthermore, in some embodiments, a record of an event may be simplified by, for example, recording that the developer has performed a touch or a click without recording which GUI element the developer clicks on. Using the usage scenarios shown in FIG. 4A and FIG. 4B, GUI shadow data created may be created as is shown below in Table 1, which illustrates an example of XML GUI shadow data. In Table 1, WidgetAction represents a combination of specific event information and a related response action that enables the management program 112 to demonstrate a specific operation of the software product and a result thereof.

```
TABLE 1
<GUIShadowData>
  <widgetActionList>
    <WidgetAction name=“1”>
      <Event type=“widget” name=“button1” pos=“10,200”,
    action=“click”/>
      <Action>
        <widget name=“ResultArea” pos=“5,10” action=“Show” data=“1” />
      </Action>
  </WidgetAction>
  <WidgetAction name=“2”>
      <Event type=“widget” name=“buttonAdd” pos=“200,180”,
    action=“click”/>
      <Action>
      </Action>
    </WidgetAction>
    <WidgetAction name=“3”>
      <Event type=“widget” name=“button2” pos=“40,200”, action=“click”/>
      <Action>
        <widget name=“ResultArea” pos=“5,10” action=“Show” data=“2” />
      </Action>
    </WidgetAction>
    <WidgetAction name=“4”>
      <Event type=“widget” name=“buttonEqual” pos=“200,200”,
action=“click”/>
      <Action>
        <widget name=“ResultArea” pos=“5,10” action=“Show” data=“3” />
      </Action>
    </WidgetAction>
    <WidgetAction name=“5”>
      <Event type=“widget” name=“button3” pos=“40,200”, action=“click”/>
      <Action>
        <widget name=“ResultArea” pos=“5,10” action=“Show” data=“2” />
      </Action>
    </WidgetAction>
    <WidgetAction name=“6”>
      <Event type=“widget” name=“buttonEqual” pos=“200,200”,
action=“click”/>
      <Action>
        <widget name=“ResultArea” pos=“5,10” action=“Show” data=“4” />
      </Action>
    </WidgetAction>
  </widgetActionList>
  <path>
    <WidgetAction name=“1”> 1
      <WidgetAction name=“2”/> +
        <WidgetAction name=“3”/> 2
          <WidgetAction name=“4”/> =3
        <WidgetAction name=“5”/> 3
          <WidgetAction name=“6”/> =4
    </widgetAction>
  </path>
</GUIShadowData>
```

The action record generates a program file such that, upon completion of a recording process, the user may compile a program for automatically executing all actions which have been recorded. In block 306, to record an action, the system records an event and an action corresponding thereto and creates the GUI shadow data according to the recorded event and action, and then the management program 112 enables the user to operate the program interactively with the GUI shadow data so as to achieve the demonstration of the software product.

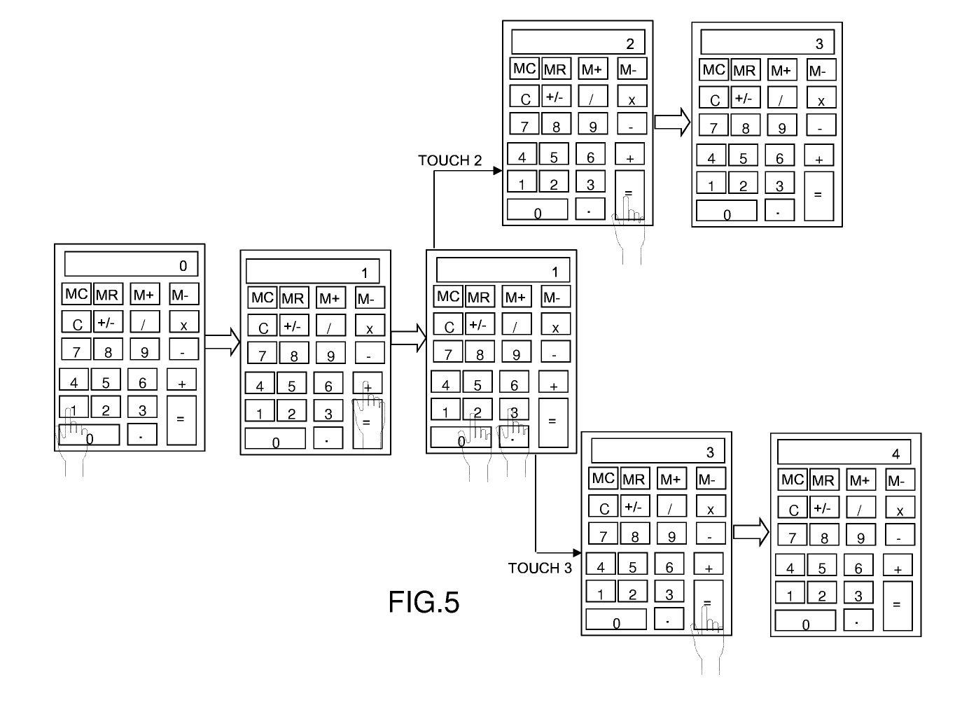

Lastly, in block 308 of FIG. 3, the GUI shadow data created in block 306 and the finalized software product may be stored together on the servers 20 (or may be stored on different servers in some embodiments), such that the user downloads the GUI shadow data by following the process flow illustrated with FIG. 2, and demonstrates the software product at the terminal device 10 according to the downloaded GUI shadow data. Referring to the example shown in FIG. 5, the user may click sequentially on GUI elements in the software demonstration, such as keys “1”, “+”, “2”, “=”, simulating a “1+2=” computation operation requirement of the GUI shadow data, and then the GUI element determines that the user's clicking sequentially on the keys “1”, “+”, “2”, “=” satisfies a predefined event that is defined in the GUI shadow data in the scenario of FIG. 4A, and gives a response action of a result “3”. Similarly, the user may click sequentially on GUI elements in the software demonstration, such as keys “1”, “+”, “3”, “=, simulating a “1+3=” computation operation requirement of the GUI shadow data, and then the GUI element determines that the user's clicking sequentially on the keys “1”, “+”, “3”, “=” satisfies a predefined event that is defined in the GUI shadow data in the scenario of FIG. 4B, and gives a response action of a result “4”.

The demonstration performed in block 308 does not involve a computation operation of “1+2=3” or “1+3=4”, nor is it capable of computation typical of a software product. A GUI element presents information according to a script defined by the GUI shadow data, because the sequence in which the user clicks on GUI elements (such as the keys discussed above) is also regarded as one of the criteria of an event. Hence, if the operations or functions provided by the software product are not recorded in the GUI shadow data in blocks 304 and 306, it will be impossible to demonstrate the operations or functions provided by the software product in block 308. For example, in blocks 304 and 306, when only the “1+2=3” operation shown in FIG. 4A or the “1+3=4” operation shown in FIG. 4B are recorded in the GUI shadow data, the computation operation of “2+1=3” or “3+1=4”, which is substantially identical to the former but distinguished from the former in terms of operation sequence, may be demonstrated in block 308.

Nonetheless, the above-mentioned should not be regarded as a disadvantage at least because the GUI shadow data of embodiments described herein are intended to serve as a basis of demonstration of a software product rather than designed to replace a software tool.

Embodiments described herein, where demonstration is effectuated by means of the GUI shadow data GUI element (widget), are capable of dynamic demonstration and interaction with a user, and thus the GUI shadow data assists the user in understanding how the software product works. Furthermore, in general, unlike the conventional way of downloading a software product (or lite version of a software product) in its entirety, embodiments described herein allow for downloading the GUI shadow data and executing the demonstration of the software product in a manner that requires less data and thus results in a higher transmission speed.

In an embodiment of the present invention, a method for creating GUI shadow data for use with the terminal device includes the following actions performed in an IDE of the software product: compiling source codes of the software product and generating executable codes; executing the executable codes of the software product in a demo mode of the IDE; using the software product in a predetermined usage scenario; recording at least an event happening to the software product in the predetermined usage scenario and at least an action responding to the at least an event; and creating the GUI shadow data based on the event and the action.

As described above with respect to FIG. 1 through FIG. 5, terminal devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a terminal device, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propogate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using optical fiber cable, RF, etc. any appropriate medium, including but not limited to wireless, wireline,

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of embodiments of the invention may be combined in any suitable manner in one or more embodiments. One skilled in the relevant art will recognize that embodiments of the invention may be practiced without one or more of the specific features or advantages of a particular embodiment. In other instances, additional features and advantages may be recognized in certain embodiments that may not be present in all embodiments of the invention.

The foregoing embodiments are provided to illustrate and disclose the technical features of embodiments of the invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

What is claimed is:

1. A terminal device connected to a server, the terminal device comprising:
a processor for executing a management program to perform a method comprising:
providing a management interface to a user;
receiving a selection of a software product from the user via the management interface;
downloading graphical user interface (GUI) shadow data corresponding to the software product from the server; and
demonstrating the software product on the terminal device according to the GUI shadow data.

2. The terminal device of claim 1, wherein, after demonstrating the software product on the terminal device according to the GUI shadow data, the management program further downloads the software product for installation on the terminal device.

3. The terminal device of claim 1, wherein the GUI shadow data is in a markup language format.

4. The terminal device of claim 1, wherein downloading the GUI shadow data corresponding to the software product from the server is executed in a background of the management program.

5. The terminal device of claim 1, wherein demonstrating the software product on the terminal device according to the GUI shadow data further comprises demonstrating the software product at the management interface.

6. The terminal device of claim 1, wherein demonstrating the software product on the terminal device according to the GUI shadow data further comprises demonstrating a predetermined usage scenario in the software product.

7. The terminal device of claim 1, wherein the GUI shadow data comprises at least a predefined set of related events and actions, and wherein demonstrating the software product on the terminal device according to the GUI shadow data further comprises demonstrating the software product according to the predefined set of related events and actions.

8. The terminal device of claim 1, further comprising creating the GUI shadow data, wherein creating the GUI shadow data comprises:
compiling source code of the software product by a computer to generate executable code;
executing the executable code of the software product in a demo mode of an integrated development environment (IDE);
operating the software product in a predetermined usage scenario in the IDE;
recording an event occurring during the operation of the software product in the IDE in the predetermined usage scenario;
recording an action responding to the event; and
creating the GUI shadow data based on the event and the action.

9. A method for demonstrating a software product on a terminal device, the method comprising:
providing a management interface associated with a management program to a user by the terminal device;
receiving a selection of a software product from the user via the management interface;
downloading graphical user interface (GUI) shadow data corresponding to the software product from a server; and
demonstrating the software product on the terminal device according to the GUI shadow data.

10. The method of claim 9, wherein, after demonstrating the software product on the terminal device according to the GUI shadow data, the management program further downloads the software product to be installed on the terminal device.

11. The method of claim 9, wherein downloading GUI shadow data corresponding to the software product from the server is executed in a background of the management program.

12. The method of claim 9, wherein demonstrating the software product on the terminal device according to the GUI shadow data further comprises demonstrating the software product at the management interface.

13. The method of claim 9, wherein demonstrating the software product on the terminal device according to the GUI shadow data further comprises demonstrating a predetermined usage scenario in the software product.

14. The method of claim 9, wherein the GUI shadow data comprises at least a predefined set of related events and actions, wherein demonstrating the software product on the terminal device according to the GUI shadow data further comprises demonstrating the software product according to the predefined set of related events and actions.

15. The method of claim 9, further comprising creating the GUI shadow data, wherein creating the GUI shadow data comprises:
compiling source code of the software product by a computer to generate executable code;
executing the executable code of the software product in a demo mode of an integrated development environment (IDE);
operating the software product in a predetermined usage scenario in the IDE;
recording an event occurring during the operation of the software product in the IDE in the predetermined usage scenario;
recording an action responding to the event; and
creating the GUI shadow data based on the event and the action.

16. A computer program product for enabling demonstration of a software product on a terminal device, the computer program product comprising:
a computer readable storage medium having computer readable program code embodied therewith, the computer readable program code comprising:
computer readable program code configured to perform:
providing a management interface associated with a management program to a user;
receiving a selection of a software product from the user via the management interface; and
sending graphical user interface (GUI) shadow data corresponding to the software product from a server to said terminal device, thereby enabling demonstration of the software product on the terminal device according to the GUI shadow data.

17. The computer program product of claim 16, wherein the computer readable program code is further configured to perform sending the software product from the server to said terminal device.

18. The computer program product of claim 16, wherein the GUI shadow data comprises a predefined set of related events and actions that are utilized in the demonstration of the software product on the terminal device.

19. The computer program product of claim 16, wherein the computer readable program code is further configured to perform:
creating the GUI shadow data, wherein creating the GUI shadow data comprises:
compiling source code of the software product to generate executable code;
executing the executable code of the software product in a demo mode of an integrated development environment (IDE);
operating the software product in a predetermined usage scenario in the IDE;
recording an event occurring during the operation of the software product in the IDE in the predetermined usage scenario;
recording an action responding to the event; and
creating the GUI shadow data based on the event and the action.

20. The computer program product of claim 16, wherein the GUI shadow data is in a markup language format.

21. A method for demonstrating a software product, the method comprising:
providing by a server, in response to a software product selected by a user via a terminal device, GUI shadow data created using predetermined event information and actions for downloading by the terminal device, wherein the GUI shadow data enables the terminal device to demonstrate the software product.

22. The method of claim 21, wherein the method further comprises sending the software product from the server to said terminal device.

23. The method of claim 21, wherein the GUI shadow data comprises a predefined set of related events and actions that are utilized to demonstrate the software product on the terminal device.

24. The method of claim 21, wherein the method further comprises:
creating the GUI shadow data, wherein creating the GUI shadow data comprises:
compiling source code of the software product to generate executable code;
executing the executable code of the software product in a demo mode of an integrated development environment (IDE);
operating the software product in a predetermined usage scenario in the IDE;
recording an event occurring during the operation of the software product in the IDE in the predetermined usage scenario;
recording an action responding to the event; and
creating the GUI shadow data based on the event and the action.

25. The method of claim 21, wherein the GUI shadow data is in a markup language format.
